(19) United States
(12) Patent Application Publication
(10) Pub. No.: US 2013/0299309 A1
(43) Pub. Date: Nov. 14, 2013

(54) Conveyor Apparatus and Related Method of Conveying

(71) Applicants: James Harper Moffitt, York, PA (US); Daniel Scott Spurlin, Enola, PA (US)

(72) Inventors: James Harper Moffitt, York, PA (US); Daniel Scott Spurlin, Enola, PA (US)

(21) Appl. No.: 13/466,230

(22) Filed: May 8, 2012

(51) Int. Cl. B65G 47/244

(52) U.S. Cl. 198/413

(57) ABSTRACT

A conveyor apparatus for reorienting a conveyed article with respect to its line of travel includes a rotating disk that receives an article from a first conveyor and discharges the article to the second conveyor. While the article is being discharged, it pivots around an edge of the rotating disk.

### FIELD OF THE INVENTION

The invention relates to methods and apparatus for conveying articles, and particularly for changing the orientation of articles being conveyed.

### BACKGROUND OF THE INVENTION

Plastic blow molded containers are ejected from a blow molding machine and are conveyed to a processing station for de-flashing or trimming. Non-round containers may be oriented in a first direction when conveyed away from the blow molding machine but may need to be re-oriented substantially 180° when delivered to the processing station.

Apparatus for rotating articles 90° are known, and two such apparatus could be utilized serially to rotate the containers 180° before delivery to the processing station. However, separate rotations of 90° take up valuable floor space and that floor space may not be available. Furthermore, not all non-round container shapes are compatible with the known apparatus.

Thus there is a need for a conveyor apparatus that can re-orient articles being conveyed, such as non-round blow molded containers, 180° in one step and with greater flexibility with respect to the shape of the article capable of being re-oriented.

### SUMMARY OF THE INVENTION

The present invention relates to a conveyor apparatus that is capable of re-orienting an article 180° from a first orientation to a second orientation in one step and with greater flexibility with respect to the shape of the article being re-oriented.

A conveyor apparatus in accordance with the present invention revolves the article about a stationary vertical axis to rotate the article a first angular displacement from the first orientation, and then pivotally rotates the article a second angular displacement in addition to the first angular displacement before fully discharging the article onto the second conveyor. The combined angular displacements enable a greater change in article orientation than that provided by revolving the article alone.

A preferred embodiment of a conveyor apparatus in accordance with the present invention has a body rotatable in a direction about a vertical axis. The body is preferably formed as an annular disk having one or more pockets or slots, each slot extending inwardly into the body to a closed end of the slot.

Each slot is defined at least partially by a leading edge and a trailing edge, the leading and trailing edges extending from the closed end of the slot and radially spaced apart from one another. The leading edge is shorter than the trailing edge so that a radially outer portion of the slot is open and unobstructed by the body from the trailing edge in the circumferential direction.

The disk is placed over the downstream end of a first conveyor and an upstream end of a second conveyor, the conveyors located such that the slot moves over and essentially parallel with the first conveyor to receive an article from the conveyor into the slot, and the slot moves over and is transverse to the second conveyor to discharge an article from the slot onto the second conveyor. The second conveyor engages the article and generates a torque on the article urging the article to pivot around the leading edge of the slot as the article is discharged out of the slot.

The conveyor apparatus of the present invention enables an article to be reoriented with a greater angular displacement with respect its line of travel than that provided by revolving the article alone, saving valuable floor space. Since the articles are received into slots conformed to closely receive the article, the conveyer apparatus can be adapted with greater flexibility to the shape of the article being conveyed.

Other objects and features of the invention will become apparent as the description proceeds, especially when taken in conjunction with the accompanying drawing sheets illustrating embodiments of the invention.

### BRIEF DESCRIPTIONS OF THE DRAWINGS

FIG. 1 is a top view of a conveyor apparatus in accordance with the present invention used for conveying non-round blow molded containers from a blow molding machine to a de-flashing station;

FIG. 2 is a side view of the conveyor apparatus shown in FIG. 1;

FIG. 3 is a top view of the star wheel forming part of the conveyor apparatus shown in FIG. 1;

FIG. 4 is an enlarged view of one of the slots of the star wheel shown in FIG. 3;

FIGS. 5-8 illustrate operation of the conveyor apparatus shown in FIG. 1 in re-orienting a container 180 degrees in its line of travel from the blow molding machine to the de-flashing station; and

FIG. 9 illustrates is a view similar to FIG. 4 of a slot of a star wheel used in a second embodiment of the present invention.

### DESCRIPTION OF THE PREFERRED EMBODIMENTS

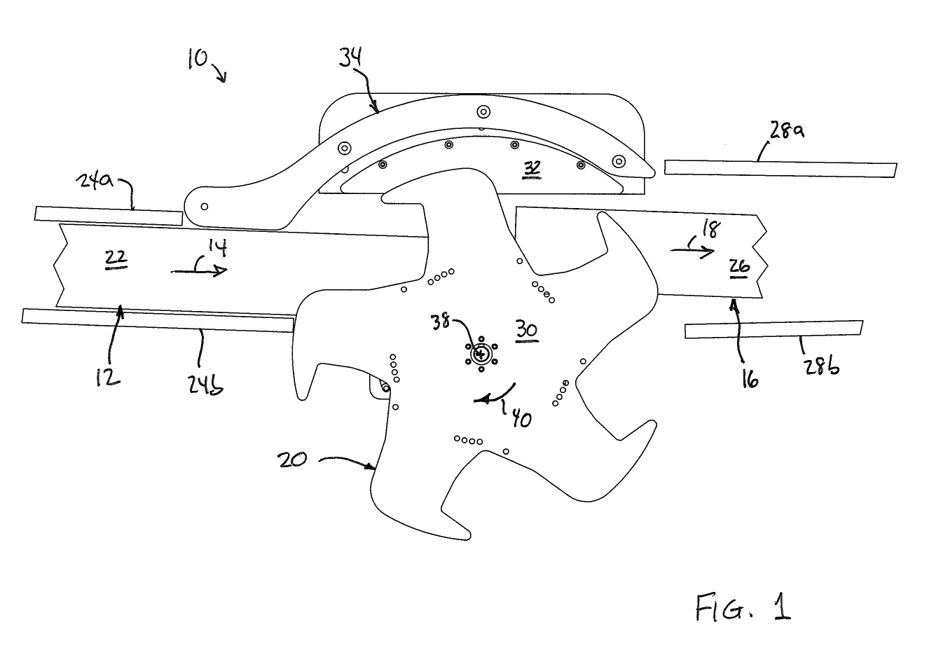

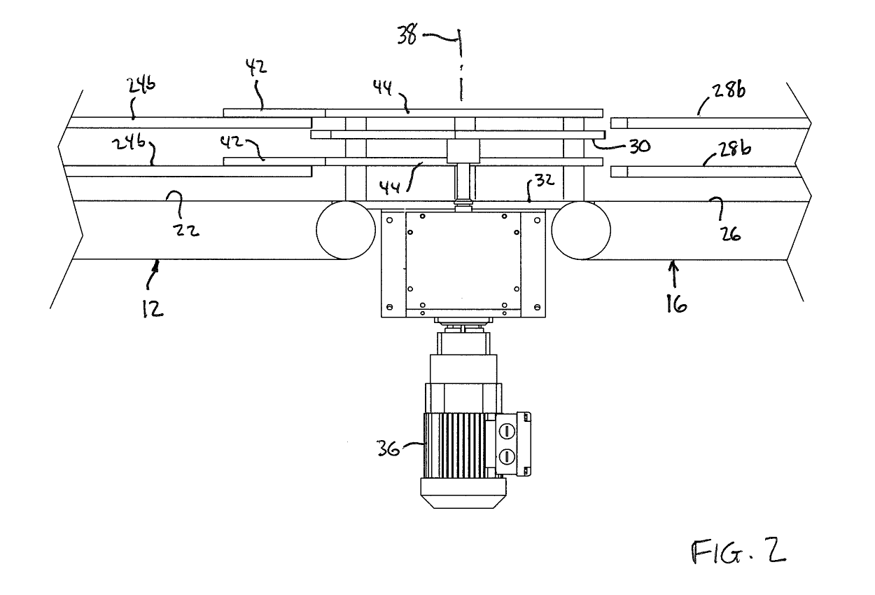

FIGS. 1 and 2 illustrate a conveyor apparatus 10 in accordance with the present invention. The conveyor apparatus 10 includes a first, upstream conveyor 12 that conveys containers in a linear first travel direction indicated by the arrow 14 and a second, downstream conveyor 16 that conveys containers in a linear second travel direction indicated by the arrow 18. Between the conveyors 12, 16 is a rotary transfer apparatus 20 that receives containers from the upstream conveyor 12 and transfers the containers to the downstream conveyor 16. The rotary transfer apparatus 20 cooperates with the downstream conveyor 16 to rotate the containers approximately 180° with respect to the lines of travel 14, 18 as will be described in greater detail below.

The illustrated conveyor apparatus 10 is used in conveying empty, non-round plastic containers from a blow molding machine (not shown) to a de-flashing station (not shown). The upstream conveyor 12 receives the containers in a first orientation from the blow molding machine and the downstream conveyor 16 delivers the containers in a second orientation rotated 180° from the first orientation to the de-flashing station.

The upstream conveyor 12 includes a horizontal conveyor belt that carries the containers in the travel direction 14. Railings or guide fences 24a, 24b extend along the sides of the conveyor belt 22. The downstream conveyor 16 includes a horizontal conveyor belt 26 co-planar with the conveyor belt 22 that carries the containers in the travel direction 18. Railings or guide fences 28a, 28b extend along the sides of the conveyor belt 26.

The rotary transfer apparatus 20 includes a horizontal disk or star wheel 30, a horizontal floor 32, and a guide assembly 34. The star wheel 30 is driven by a motor 36 to rotate about a vertical axis of rotation 38 in the direction of rotation indicated by the arrow 40. The star wheel 30 is spaced above and overlays end portions of the conveyor belts 22, 26 to receive containers from the conveyor belt 22 and discharge containers to the belt 26. The floor 32 is essentially even with the conveyor belts 22, 26 and extends between the belts to support containers moving from the belt 22 to the belt 26. The guide assembly 34 includes a set of vertically spaced flat lead-in surfaces 42 connected to curved cam surfaces 44 that extend in the direction of rotation around the star wheel 30 from the upstream conveyor 14 to the downstream conveyor 16.

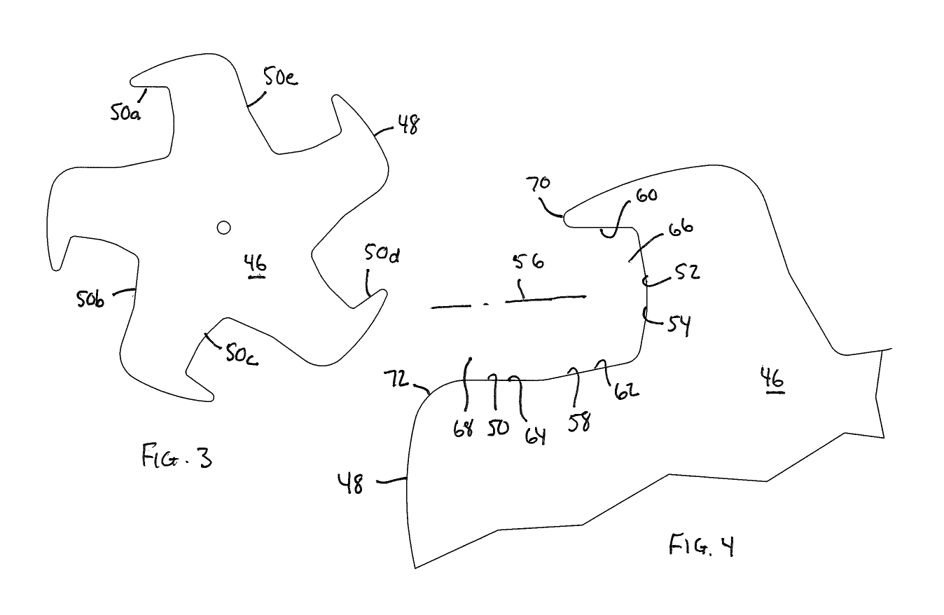

FIG. 3 illustrates only the star wheel 30. The star wheel 30 consists of an annular body 46 bounded by a circular outer periphery or outer edge 48, with a set of circumferentially spaced pockets or slots 50a, 50b, 50c, 50d, 50e formed in the body 46. The illustrated star wheel 30 has five like, equally spaced slots 50.

FIG. 4 illustrates in greater detail one of the slots 50. The slot 50 extends into the body 46 from the outer periphery 48 to a closed end 52 defined by an inner edge 54. The slot 50 extends along a longitudinal axis 56 radially spaced from the axis of rotation 38.

The slot 50 is bounded by a trailing edge 58 extending along the longitudinal axis 56 from one end of the inner edge 54 to the periphery 48, and a leading edge 60 extending along the axis 56 from the other end of the inner edge 54 to the outer periphery 48. The leading edge 60 is spaced from the trailing edge 58 and extends a substantially shorter distance than the trailing edge 58, the leading edge 60 dividing the trailing edge 58 into an inner edge portion 62 facing the leading edge 60 and an outer edge portion 64 extending from the inner edge portion 62 to the disk periphery 48. The leading edge 60 and the inner edge portion 62 are on opposite sides of the slot axis 56 and define an inner slot portion 66 bounded on opposite sides by the edges 60, 62, with the remainder of the slot 50 being an outer slot portion 68 bounded by the outer edge portion 64. The outer slot portion 68 is unobstructed by the body 46 from the outer edge portion 64 in the direction generally perpendicular to the slot axis 56.

The leading edge 60 intersects the disk periphery 48 at a relatively sharp acute angle, the intersection defining a corner 70 that is rounded to assist in the discharge of a container from the slot 50 as will be explained in greater detail below. The corner 72 defined by the intersection of the trailing edge 58 and the disk periphery 48 is also rounded to assist in the intake of a container into the slot 50 as will be explained in greater detail below.

Referring back to FIGS. 1 and 2, the star wheel 30 is located above the conveyors 12, 16 and is preferably located below the center of gravity of containers conveyed by the conveyors 12, 16. During rotation of the star wheel 30 the slots 50 move over the downstream end portion of the conveyor 12 to receive containers from the conveyor 12, and move over the upstream end portion of the conveyor 16 to discharge containers onto the conveyor 16. The upstream conveyor 12 is oriented with respect to the star wheel 30 such that the slot axis 56 is approaching parallel with the conveyor direction of travel 14 as a slot 50 begins to move over the conveyor 12, and the downstream conveyor 16 is oriented with respect to the star wheel 30 such that the slot axis 56 is approaching perpendicular with the conveyor direction of travel 18 as a slot 50 begins to move over the conveyor 16.

In the illustrated embodiment the directions of travel 14, are parallel with one another. The star wheel 30 rotates about 90° to move a slot 50 from the upstream conveyor 12 to the downstream conveyor 16. In other embodiments of the conveyor apparatus 10 the directions of travel 14, 16 can be non-parallel or transverse to one another and the star wheel 30 may rotate more or less than about 90° to move a slot from the upstream conveyor to the downstream conveyor.

The lead-in surfaces 42 extend from the rail or fence 24a to the star wheel 30. The surfaces 42 are vertically spaced preferably along substantially the full height of a container to resist tipping of containers moving against the surfaces 42.

The curved cam surfaces 44 extend from the lead-in surfaces to the rail or fence 28a. The cam surfaces 44 are also vertically spaced preferably along substantially the full height of a container to resist tipping of containers moving against the surfaces 44. The cam surfaces 44 have a curvature whose center is offset from the axis of rotation 38 so that the distance from the cam surfaces 44 to the axis 38 decreases in the direction of rotation.

Operation of the conveyor apparatus 10 is discussed next.

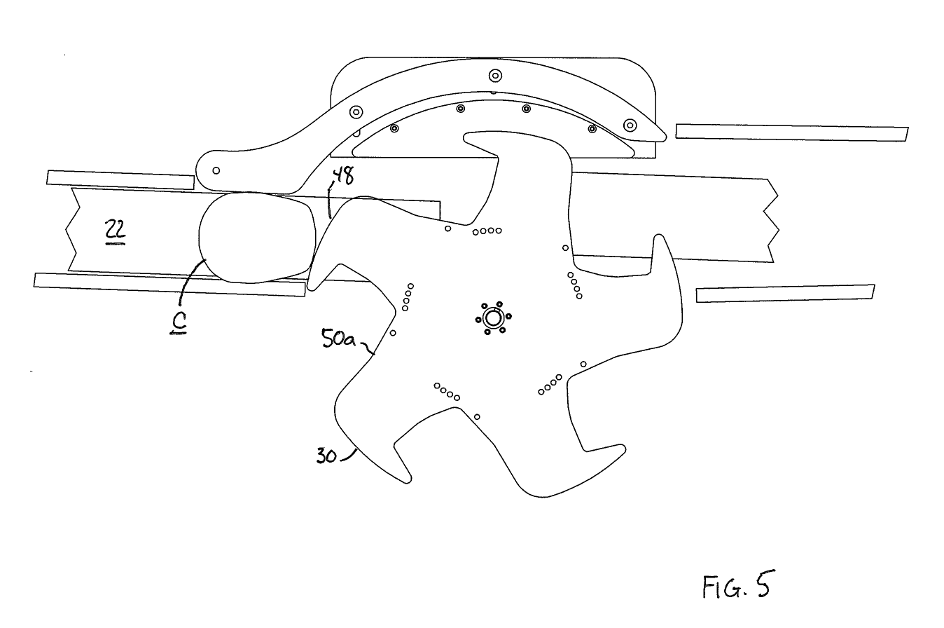

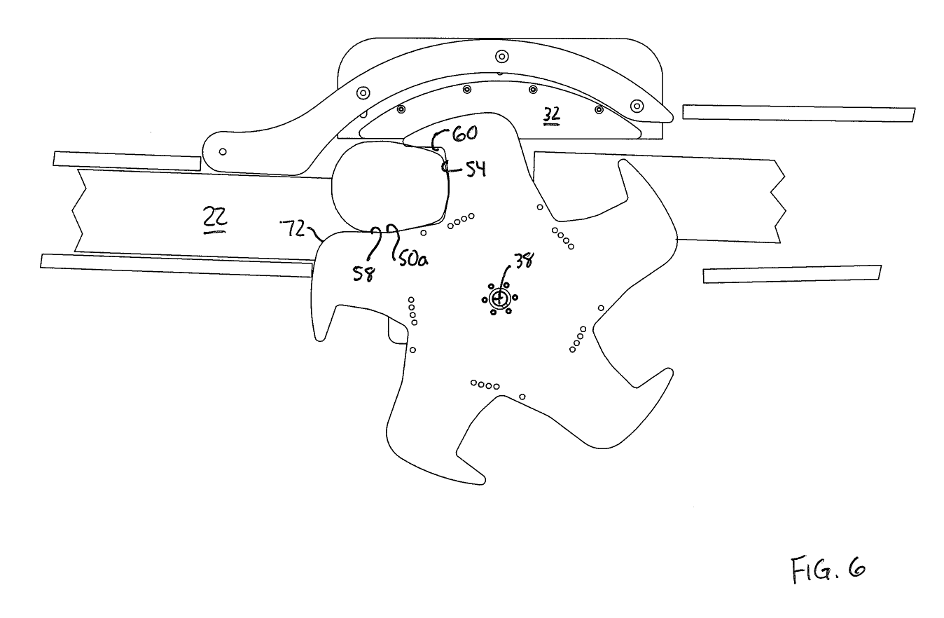

FIG. 5 illustrates a container C in a first orientation on the conveyor belt 22, the belt 22 urging the container C in the direction 14 shown in FIG. 1. The star wheel 30 is located in its rotation with its periphery 48 blocking movement of the container C and the slot 50a approaching the belt 22. The container C may be substantially stationary on the belt 22 waiting for the arrival of the slot 50a.

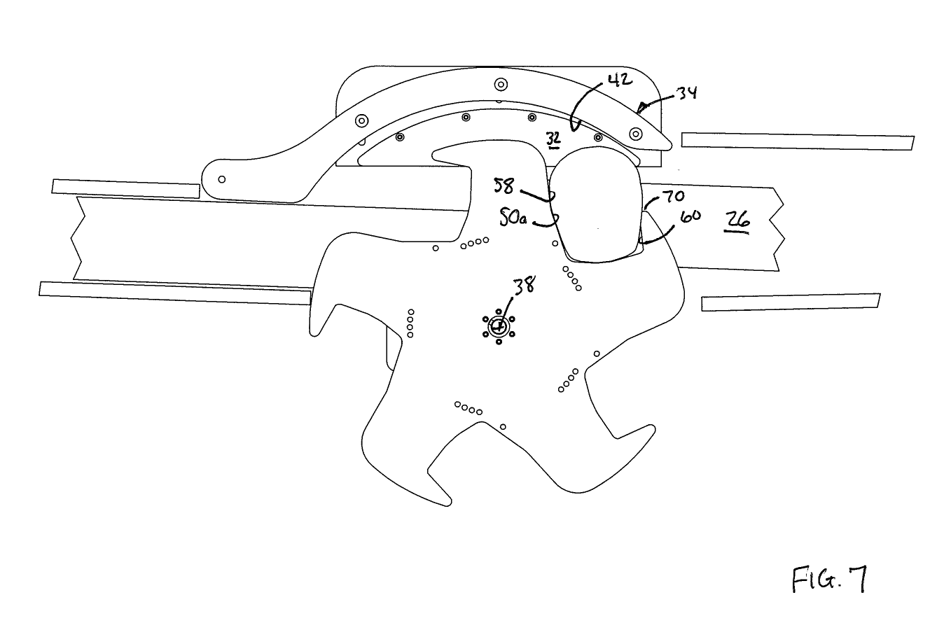

FIG. 6 illustrates the conveyor apparatus 10 after the slot leading edge 60 has cleared the conveyor belt 22. As seen in FIG. 6, the container C is moving off the conveyor belt 22 and onto the floor 32. The rounded corner 72 has moved over the conveyor belt 22 and separates the container C from an adjacent upstream container that might be in contact against the container C. The belt 22 has urged the container C to move into the opening of the slot 50a. The slot edges 54, 58, 60 are shaped such that the pocket 50a closely receives the container C.

When the container C is received into the slot 50a, the flat leading edge 60 engages against a flat surface of the container C and the trailing edge 58 extends along a side of the container C to urge the container C to revolve around the axis of rotation 38. Preferably the trailing edge 58 engages the side of the container C on opposite sides of the container's center of gravity so that the container remains against the trailing edge 58 as the container moves with the star wheel 30.

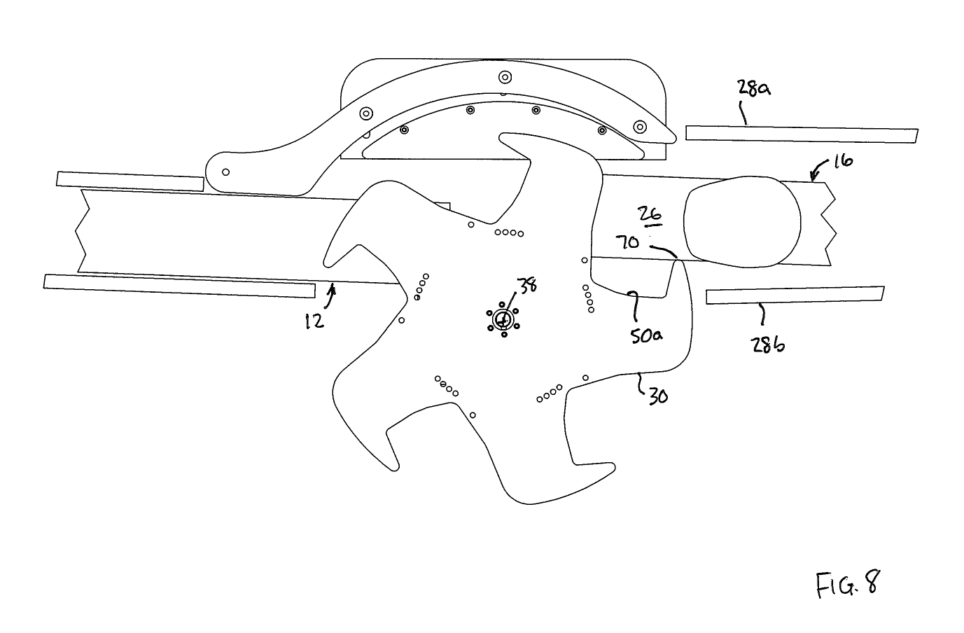

FIG. 7 illustrates the conveyor apparatus 10 after the slot leading edge 60 has moved over the belt 26 and is approaching perpendicular to the direction of travel 18 shown in FIG. 1. The container C has revolved about the rotational axis 38 about 90° and, being constrained in the slot 50a, has also rotated about 90° around its own vertical axis from the container's orientation shown in FIG. 6 to its orientation shown in FIG. 7. As the container C revolved about the rotational axis 38, the radial outer portion of the container C moved along the curved cam surfaces 42. If the container C were not initially fully received into the slot 50a, the container C engages the cam surfaces 42 which urge the container C into the slot 50a. This assures that the container C is fully within the slot 50a prior to discharge from the slot 50a.

In the position shown in FIG. 7, the container C is moving off the floor 32 and onto the belt 26. The belt 26 applies a frictional force to the container C in the direction of arrow 18 shown in FIG. 1, the force urging the container C to move away from the trailing edge 58 and to move against the leading edge 60. The contact of a portion of the side of the container C against the leading edge 60, causing the frictional force to generate a moment or torque acting on the container C urging the container to pivot about the corner 70 in the clockwise direction as viewed in FIG. 7. The container C begins pivoting about the corner 70 in response to the torque. The outer portion 68 of the slot 50 is unobstructed in the direction of pivoting of the container C to enable the container to pivot and move out of the slot 50. The container C has cleared the guide assembly 34 so that the assembly 34 does not interfere with pivoting of the container. The container C pivotally rotates out of the slot 50a and onto the conveyor belt 26.

The corner 70 is rounded to facilitate rotation of the container C out of the slot 50a, and the trailing edge 58 is slightly concave to provide clearance relief as the container rotates about 90° and out of the slot 50a. Preferably the leading edge 60 stops well short of the center of gravity of the container C to maximize the torque or moment urging the container C to pivot and rotate about the corner 70. In the illustrated embodiment the trailing edge 58 extends longitudinally the full length of the container C while the leading edge 60 extends longitudinally substantially less than half the distance of the edge 58; preferably the leading edge 60 terminates well short of pulling along even with the center of gravity of the container C.

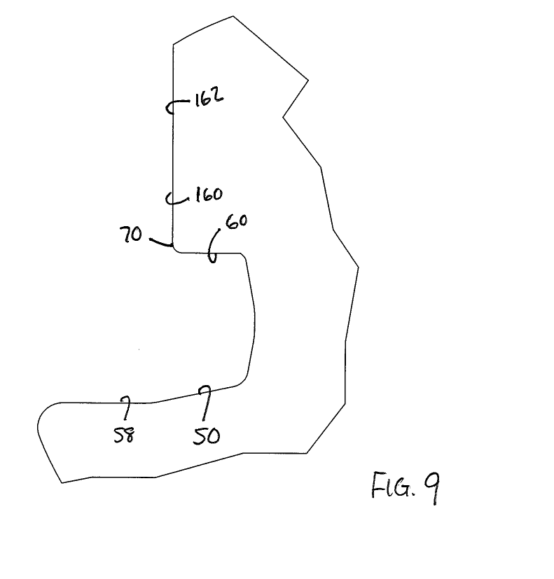

FIG. 8 illustrates the conveyor apparatus 10 after the container C has moved onto the conveyor belt 26 and is clear of the star wheel 30. The container C has rotated about 90 degrees clockwise as viewed in the figure as it revolves around the axis of rotation 38 in the pocket 50a from the conveyor 12 to the conveyor 16, and then pivots about 90 degrees clockwise as viewed in the figure out of the slot 50a about the corner 70, out of the slot 50a and onto the conveyor belt 26 while the slot 50a is passing over the conveyor 16. As a result, the container C when moving from the conveyor 12 and onto the conveyor 16 rotates from its original orientation with respect to its original line of travel 14 about 180 degrees to its new orientation with respect to its new line of travel 18.

The fence or guide rails 28a, 28b are spaced relatively wide apart adjacent the star wheel 30 to accommodate the rotation of the container C out of the slot 50a and onto the conveyor belt 26. The guide rails 28a, 28b taper inwardly towards each other as they extend in the direction of travel 18 away from the star wheel 30 to correct for any under-rotation or over-rotation of the container C out of the slot 50a and assures proper orientation of the container as it travels downstream on the conveyor belt 26 to the de-flashing station.

Each slot 50 of the star wheel 30 shown in FIG. 3 is radially offset from the rotational axis 38, enabling the slot's leading edge 60 to extend from the inner slot edge 54 to the wheel periphery 48 while still enabling a container C to pivot out of the slot. FIG. 9 illustrates a second embodiment of a slot 50 formed in the body 46, the slot not radially offset from the star wheel's axis of rotation. In this embodiment the leading edge 160 includes a first edge 60 like the edge 60 in the first embodiment slot 50 and a second edge 162 extending from the edge 60 and away from the trailing edge 58. A container held in the slot 50 can pivot about the corner 70 when exiting the slot as previously described.

In FIG. 9 the edge 162 is essentially perpendicular to the longitudinal axis of the slot 50 to limit the pivotal displacement of the container; in other embodiments the edge 162 can be oriented at a different angle with respect to the slot axis to enable more or less pivotal displacement.

The illustrated embodiments have the axis of rotation of the body 45 spaced from the slot(s) 50. In alternative embodiments of the invention, the axis of rotation of the body 46 can pass through the slot 50, that is, the axis of revolution of a container moving from the first conveyor to the second conveyor can pass through the container itself.

The diameter of the star wheel 30 and the shape and number of the slots 50 can be different in other embodiments of the conveyor apparatus 10 to accommodate receiving and pivotally rotating containers of other shapes, sizes, and materials.

Different types of conveyors known in the conveying art can be used in alternative embodiments of the invention, and the upstream and downstream conveyers can be a different type of conveyors from the other.

In yet other possible embodiments the upstream conveyor 14 and the downstream conveyor 16 can be portions of a single conveyor whose belt is sufficiently wide to accommodate rotation of the container by the star wheel without the container leaving the belt. In such embodiments the fences or railings can be located over the conveyor belt to align the containers for entry into the star wheel and for discharge from the star wheel.

While this disclosure has illustrated and described preferred embodiments of the invention, it is understood that this is capable of modification, and that the invention is not limited to the precise details set forth, but includes such changes and alterations as fall within the purview of the following claims.

1. A conveyor apparatus for reorienting a conveyed article with respect to its line of travel, the apparatus comprising:
a first conveyor, a second conveyor, and a rotary transfer apparatus between the first and second conveyors;
the first conveyor having a downstream end portion that urges articles on the downstream conveyor portion in a first direction of travel towards the rotary transfer apparatus, the second conveyor having an upstream end portion that urges articles on the upstream conveyor portion in a second direction of travel away from the rotary transfer apparatus;
the rotary transfer apparatus comprising a body rotatable about a vertical axis of rotation, the body having an outer periphery and a slot extending into the body from the outer periphery;
the slot extending along a horizontal axis into the body to a closed end, the slot being defined at least partially by a leading edge and a trailing edge on opposite sides of the horizontal axis, the leading edge and trailing edge spaced apart from one another in a direction perpendicular to the horizontal axis, the trailing edge extending from the closed end of the slot a first length and the leading edge extending from the closed end of the slot inner edge a second, substantially shorter length, the trailing edge comprising an inner edge portion facing the upstream edge and an outer edge portion extending from the inner edge portion to the periphery, the slot unobstructed from the outer edge portion in the direction perpendicular to the horizontal axis; and
the body being disposed such that the slot moves over the downstream end portion of the first conveyor and then over the upstream end portion of the second conveyor during a rotation of the body, the horizontal axis of the slot becoming parallel with the first direction of travel while the slot is moving over the first conveyor for receiving an article from the first conveyor into the slot, the horizontal axis of the slot becoming transverse to the second direction of travel while the slot is moving over the second conveyor for discharging the article from the slot onto the second conveyor.

2. The conveyor apparatus of claim 1 wherein the downstream end portion of the first conveyor extends along a first linear axis and the upstream end portion of the second conveyor extends along a second linear axis not co-linear with the first axis.

3. The conveyor apparatus of claim 2 wherein the first axis is parallel with the second axis.

4. The conveyor apparatus of claim 1 wherein the downstream end portion of the first conveyor is not radially aligned with the axis of rotation.

5. The conveyor apparatus of claim 1 wherein the upstream end portion of the second conveyor comprises a pair of spaced-apart guide surfaces extending away from the disk, the guide surfaces approaching one another as the guide surfaces extend away from the disk.

6. The conveyor apparatus of claim 1 wherein the leading edge extends from the closed end of the slot to a rounded corner.

7. The conveyor apparatus of claim 1 wherein the slot represents a first slot and the body is an annular disk comprising one or more additional slots like the first slot, the first slot and the one or more additional slots circumferentially spaced apart from one another.

8. The conveyor apparatus of claim 1 comprising a floor beneath the body and between the first and second conveyors;
the slot at least partially overlaying the floor when the slot is moving from over the first conveyor to over the second conveyor, the floor being configured to at least partially support an article in the slot moving from the first conveyor to the second conveyor.

9. The conveyor apparatus of claim 1 wherein the trailing edge comprises a concave edge portion.

10. The conveyor apparatus of claim 1 wherein the intersection of the trailing edge and the outer periphery of the body is rounded.

11. The conveyor apparatus of claim 1 wherein the first conveyor comprises a first conveyor belt and the second conveyor comprises a second conveyor belt separate from and non-continuous with the first conveyor belt.

12. A rotary transfer apparatus for receiving articles from a first conveyor and reorienting the articles onto a second conveyor, the rotary transfer apparatus comprising;
a body rotatable in a direction about a vertical axis, the body comprising an outer periphery and one or more pockets extending inwardly into the body, each pocket of the one or more pockets extending inwardly from the outer periphery to a closed end; and
each of the one or more pockets being defined at least partially by a leading edge and a trailing edge, the leading and trailing edges extending from the closed end of the pocket and radially spaced apart from one another, the leading edge shorter than the trailing edge, a radially outer portion of the pocket open and unobstructed by the body from the trailing edge in the circumferential direction.

13. The rotary transfer apparatus of claim 12 wherein the trailing edge of each of the one or more pockets comprises a concave edge portion.

14. The rotary transfer apparatus of claim 12 wherein the trailing edge of each pocket of the one or more pockets extends along a line spaced in the radial direction from the axis of rotation.

15. The rotary transfer apparatus of claim 12 wherein the leading edge of each pocket of the one or more pockets extends from the closed end of the pocket to a rounded corner.

16. The rotary transfer apparatus of claim 12 wherein the intersection of the trailing edge of each pocket of the one or more pockets with the outer periphery of the body is rounded.

17. The rotary transfer apparatus of claim 12 comprising a stationary surface spaced below the body, the one or more pockets passing at least partially over the floor during a rotation of the body.

18. The rotary transfer apparatus of claim 12 comprising a stationary arcuate surface spaced from the body and extending partially around the body, the surface approaching the body in the direction of rotation of the body.

19. A method of reorienting an article conveyed from a first conveyor to a second conveyor, the method comprising the steps of;
(a) receiving an article from the first conveyor, the article moving in a first direction of travel and with a first orientation with respect to the first direction of travel;
(b) revolving the received article about a stationary vertical axis from the first conveyor to the second conveyor wherein the article rotates a first angular displacement from its first orientation;
(c) pivoting the article about a second vertical axis a second angular distance, the pivoting being initiated while performing step (b); and
(d) discharging the pivoted and rotated article onto the second conveyor.

20. The method of claim 19 wherein step (c) is performed after the article has revolved partway from the first conveyor to the second conveyor.

21. The method of claim 19 wherein step (c) comprises the step of:
(e) engaging the revolving article against the second conveyor and generating a frictional force between the second conveyor and the article urging the article to pivot.

22. The method of claim 23 wherein step (a) comprises revolving the article about 90° from the first conveyor to the second conveyor and step (a) comprises pivoting the article about 90°.

24. The method of claim 19 wherein step (a) comprises the step of receiving the article into a slot formed in a rotating body and step (c) comprises pivoting the article against an edge of the rotating body.

25. The method of claim 19 wherein step (b) comprises the step of revolving the received article about an axis spaced away from the article.
